(19) United States
(12) Patent Application Publication
(10) Pub. No.: US 2003/0118230 A1
(43) Pub. Date: Jun. 26, 2003

(54) Coiled tubing inspection system using image pattern recognition

(76) Inventors: Haoshi Song, Sugar Land, TX (US); James B. Terry, Houston, TX (US); James W. Estep, Houston, TX (US)

Correspondence Address: CONLEY ROSE, P.C., P. O. BOX 3267, HOUSTON, TX, 77253-3267, US

(21) Appl. No.: 10/032,272

(22) Filed: Dec. 22, 2001

(51) Int. Cl. G06K 9/00

(52) U.S. Cl. 382/152

(57) ABSTRACT

An inspection system for identifying predetermined features in coiled tubing, comprising a computer system configured to execute pattern recognition software and a plurality of imaging devices configured to capture video images of coiled tubing as the tubing passes by the imaging devices. Images captured by the inspection system are transmitted to the computer system and the pattern recognition software analyzes the image, extracts features from the image, and generates an indication if a defect is identified in the images. The computer system reads a counter signal to identify the longitudinal location along the coiled tubing at which the defect is located. The counter signal may also be used to enable or disable the inspection system. The system is capable of real-time processing or post processing by optionally storing the video images. The coiled tubing includes longitudinal striping as a reference to specify the annular position of a predetermined feature.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to the monitoring of pipes and tubing during use and more particularly to the detection of wear and defects in pipes or tubing during use. Still more specifically, the invention relates to an automated inspection and monitoring system that uses image processing and pattern recognition to locate and identify changes, wear, and defects over extensive lengths of composite coiled tubing.

2. Background of the Invention

In the field of oil well drilling, coiled tubing is becoming an increasingly common replacement for traditional steel segmented pipe. The conventional drill strings consist of hundreds of straight steel tubing segments that are screwed together at the rig floor as the string is lowered down the well bore. With coiled tubing, the drill string consists of one or more continuous lengths of coiled tubing that are spooled off one or more drums or spools and connected together for injection into the well bore from a rig as drilling progresses. By using coiled tubing, much of the time, effort, and opportunity for error and injury are eliminated from the drilling process.

FIG. 1 shows a simple illustration of how coiled tubing is implemented in an oil well drilling application. Coiled tubing 100 is stored on a reel or drum 110. As the tubing 100 is spooled off the reel 110 and directed toward the rig 120, the tubing passes through a set of guide rollers 130 attached to a levelwind 140. The levelwind 140 is used to control the position of the coiled tubing as it is spooled off and onto the service reel 110. As the tubing approaches the rig 120, the first point of contact is the gooseneck or guide arch 150. The tubing guide arch 150 provides support for the tubing and guides the tubing from the service reel through a bend radius prior to entering the rig 120. The tubing guide arch 150 may incorporate a series of rollers that center the tubing as it travels over the guide arch and towards the injector 160. The injector 160 grips the outside of the tubing and controllably provides forces for tubing deployment into and retrieval out of the well bore. It should be noted that the rig 120 shown in FIG. 1 is a simple representation of a rig. Those skilled in the art will recognize that various components are absent from FIG. 1. For instance, a fully operational rig may include a series of valves or spools as would be found on a Christmas tree or a wellhead. Such items have been omitted from FIG. 1 for clarity.

Early iterations of coiled tubing were metallic in structure, consisting for instance of carbon steel, corrosion resistant alloys, or titanium. These coiled tubes were fabricated by welding shorter lengths of tubing into a continuous string. More recent designs have incorporated composite materials. Composite coiled tubing consists of concentric layers of various materials, including for example: fiberglass, carbon fiber, and Polyvinylidene Fluoride (“PVDF”) within an epoxy or resin matrix. These materials are generally desirable in coiled tubing applications because they are lighter and more flexible, and therefore less prone to fatigue stresses induced over repeated trips on and off the reel 110. Composite coiled tubes are potentially more durable than the steel counterparts they replace, but are still subject to wear and tear over time. As a result, the condition of the coiled tubing must be regularly monitored for defects caused by wear, impact, stress, or other forces.

Furthermore, the techniques that have been used to inspect steel coiled tubing are not applicable or are less effective when used with composite tubing. For example, the acoustic and x-ray inspection techniques disclosed in U.S. Pat. Nos. 5,303,592 and 5,090,039, respectively, have been designed for use with steel coiled tubing. The density of steel makes these inspection techniques more useful with metallic tubing than with composites. Another defect detection technique is manual, visual inspection of the tubing, but this solution is simply not practical when one considers the thousands of feet of pipe that must be inspected on a regular basis. Further visual inspection is subject to human error.

Consequently, new techniques must be developed for inspecting continuous lengths of composite tubing. Sensors and contact gauges are certainly a possibility for inspecting coiled tubing, but such devices are only capable of detecting localized defects. For instance, sensors might be placed around the circumference of the tubing to take continuous measurements of the tubing as it is injected or removed from the well. In this configuration, these sensors are only capable of monitoring the outer surface of the tubing along a line traced by the sensor. It is possible that a defect may pass undetected if it lies between physical sensors of this type. Furthermore, the subterranean nature of well drilling applications is such that foreign debris or objects that are deposited on the tubing may either produce false readings or foul and damage the sensors themselves. Thus, physical contacts are not ideal for this type of inspection.

These problems may be avoided if a non-contact inspection method is used. One contemplated solution involves the use of lasers to measure the exterior dimensions of tubing as it is injected into or removed from a well. However, as with point contact sensors, lasers are also limited to localized measurements. It is therefore desirable to develop a system for automatically inspecting coiled tubing that identifies surface defects over the entire surface and length of the tubing. The inspection system preferably provides a non-intrusive method of detecting local defects such as cracks or abrasions. Further, the inspection system should also be capable of identifying large scale defects such as necking or buckling caused by axial stresses which may be identified by changes in the outer diameter of the tubing.

The present invention overcomes the deficiencies of the prior art.

### BRIEF SUMMARY OF THE INVENTION

The problems noted above are solved in large part by an automated inspection system for identifying defects in coiled tubing. The inspection system includes a computer system configured to execute pattern recognition software and a plurality of imaging devices configured to capture video images of coiled tubing as the tubing passes in front of the imaging devices. The imaging devices may be CCD cameras or fiber-optic imaging devices or some other suitable imaging device. There are preferably three imaging devices positioned 120° apart from one another about the axis of the tubing.

Images captured by the inspection system are transmitted to the computer system and the pattern recognition software analyzes the image, extracts features from the image, and generates a warning indication if a defect is identified in the images. In response to this warning indication, the computer system may issue a number of user warnings including a pop-up display on a monitor or a printout. The inspection system can identify a feature as a defect by determining if the size of an unrecognized feature exceeds a user-designated threshold. Similarly, the system may identify a feature as a defect if that feature was previously recognized as a defect and has grown beyond a user-designated percentage of its original size. The pattern recognition software further measures the outside diameter of the tubing and generates a warning indication if the diameter is outside a user-designated tolerance range.

The inspection system uses a counter or depth signal to identify a location along the coiled tubing. When a warning indication is generated by the pattern recognition software, the computer system reads the counter signal to identify the longitudinal location on the coiled tubing at which the defect is located. The counter signal may also be used to enable or disable the system. If the counter signal indicates that the coiled tubing is not moving or moving slower than a threshold, the inspection system is disabled. Conversely, if the counter signal indicates that the coiled tubing is moving faster than a threshold, the inspection system is enabled.

The inspection system further comprises a video stacker configured to correlate circumferential video images taken from the plurality of imaging devices with one another as well as with a longitudinal position along the coiled tubing using the counter signal. The video images may be transmitted to the computer system for real time identification of defects. The system may also optionally include a video recorder configured to store the video images from the plurality of imaging devices. If implemented, the stored video images are transmitted to the computer system for defect identification at some later time.

The coiled tubing used with the inspection system preferably comprises at least one longitudinal stripe on the outer surface of the tubing as a reference for the purpose of identifying the annular location of a defect on the tubing. Further, the coiled tubing may include predetermined colored layers to show wear.

Other objects and advantages of the invention will appear from the following description.

### BRIEF DESCRIPTION OF THE DRAWINGS

For a detailed description of the preferred embodiments of the invention, reference will now be made to the accompanying drawings in which:

FIG. 1 shows a conventional representation of a coiled tubing storage reel and coiled tubing extending through a rig and into a borehole;

FIG. 2 shows a diagram of a preferred embodiment of the automating tubing inspection control center capable of controlling and processing tubing images from imaging devices;

FIG. 3 shows a side view of a coiled tubing storage reel indicating the preferred location of the imaging devices positioned on the levelwind;

FIG. 4 shows a section view of the preferred coiled tubing as monitored by the imaging devices of the preferred embodiment;

FIG. 4A shows a detailed section view of the preferred coiled tubing showing various layers of the tubing;

FIG. 5 shows an isometric view of a representative section of coiled tubing for use with the preferred embodiment; and

FIG. 6 shows a representation of two images of the same defect in a tubing taken at different times and indicating how stripes on the coiled tubing may be used as circumferential references.

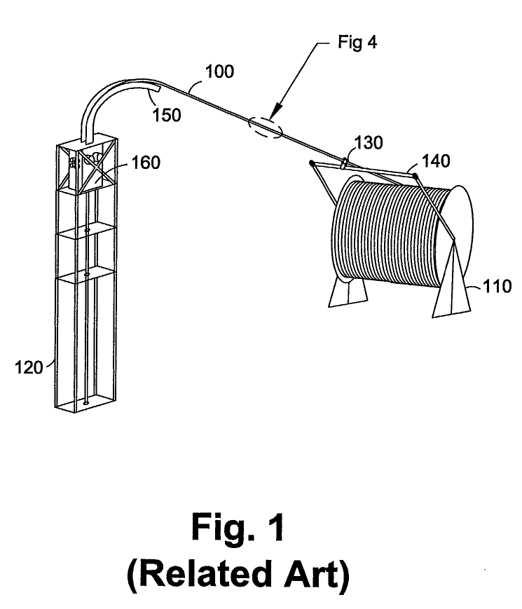

### NOTATION AND NOMENCLATURE

Certain terms are used throughout the following description and claims to refer to particular system components. As one skilled in the art will appreciate, one skilled in the art may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect electrical connection via other devices and connections.

Additionally, whereas the term “imaging device” is described below as a video camera for the purpose of describing the preferred embodiment, those skilled in the art will recognize that other imaging or image capturing devices such as still photo cameras, fiber optic imaging components, and perhaps even infrared detection devices may all be suitably configured as alternative embodiments of the improved inspection method.

### DETAILED DESCRIPTION OF THE PREFERRED EMBODIMENTS

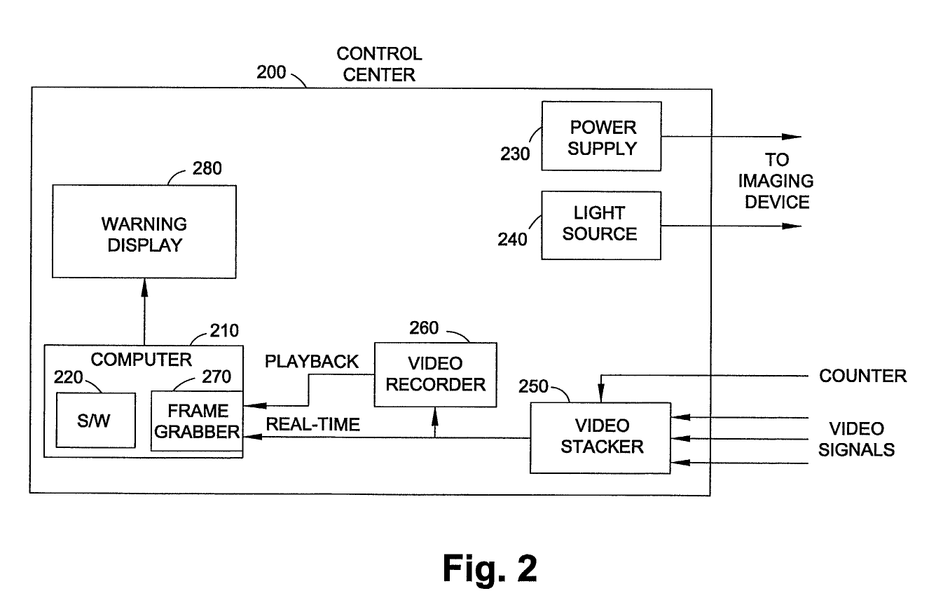

The preferred embodiment described herein generally discloses an automated inspection system that uses one or more imaging devices to generate images and/or video of coiled tubing as it is injected into or removed from the borehole of a well. These images are transmitted to a control center that handles the data in any of a variety of different ways. The images may be stored on video tape or computer disk or other suitable media. The images are transmitted to a computer system where hardware and software running on the computer will capture the video images and, with the aid of a third party image processing software bundle, process the images and scan for predetermined features on the tubing, such as unwanted defects, preferably in real time. The full scope of the preferred embodiment is described below in conjunction with related FIGS. 2-6.

Referring now to FIG. 2, a control center 200 is depicted in diagrammatical form that comprises some of the key elements of the preferred inspection system. In particular, the inspection system includes a computer system 210 configured to execute image processing and pattern recognition software 220 that is capable of detecting predefined features in tubing 100 such as wear, patterns, cracks, abrasions or defects. The control center also includes a power supply 230 and light sources 240 for any imaging devices that are used to capture video images of the coiled tubing 100. The preferred imaging devices are discussed in further detail below. Video images from the imaging devices are transmitted back to the control center where the images from the individual imaging devices are stacked by a video stacker 250 with one another and stamped with a corresponding longitudinal and circumferential position on the coiled tubing 100. The position information is provided via a counter signal that is discussed in further detail below. The stacking function of stacker 250 may be executed by computer logic or any standard video recording equipment and may entail combining the separate images or video feeds into a single feed or may simply involve correlating the video images with the position counter information. It is certainly feasible for the stacking function to be executed by computer 210 or a completely separate computer (not shown).

If real-time processing is not feasible (because of computer processing constraints) or not required, the stacked video signal can be recorded using an appropriate video recorder 260. The video recorder 260 may be an analog recorder capable of storing video on a standard VHS, SVHS, or 8 mm video tape. Similarly, the recorder may be a digital recorder capable of storing the video images on an optical disc or on magnetic tape, disk, or drive. It should also be noted that the recorder device 260 may also be capable of performing the video stacking function of stacker 250.

In further accordance with the preferred embodiment, the inspection process requires transmitting video images to computer 210 either in real-time from the imaging devices or from the recorded media in video recorder 260. The computer system 210 preferably comprises a frame grabber 270 or some other suitable video board to generate images from the incoming video signals that are recognizable by the pattern recognition software 220. The means by which the signals are transmitted to the computer, that is, the type of cable and connectors used will depend on the specific hardware employed. Thus, any industry standard video transmission cabling such as Toslink fiber optic, SPDIF, or analog RCA cables are suitable for this task.

One preferred pattern recognition software implemented in the preferred embodiment is the Aphelion™ image analysis system developed, in part, by Amerinex Applied Imaging. The Aphelion™ software package is capable of performing a variety of standard image analysis functions including morphology, segmentation, filtering, edge detection, and measurement. In addition (and perhaps more importantly) the software is capable of performing pattern recognition and classification tasks using information gathered from the above functions. The software uses binary and fuzzy logic to create rules about how information extracted from images should be interpreted. These rules are created and altered via a graphical user interface. Thus, multiple rules can be combined to make classification decisions that mimic the human decision process. Another advantage to the software package is that training sets do not need to be very large. Most common statistical and neural network pattern recognition routines require extensive training sets. Hence, operators of the preferred embodiment need merely to supply a number of sample images with representative features that should be detected (e.g., wear, cracks, abrasions, or discolorations of a certain size) or ignored (e.g., a manufacturer's marking or small defects).

Once trained and operational, the pattern recognition software 220 is capable of monitoring incoming images and extracting features from the images to determine if those features are defects that should be flagged. If such a defect is found, the software is capable of generating an interrupt or otherwise notifying the computer operating system or processor that a defect has been detected. The computer 210 then generates a warning 280 to alert the system operator of the defect. If the inspection occurs real-time, the alert may be a warning message on a computer screen or the computer may initiate a more significant warning event such as turning on flashing lights, or perhaps even forcing a shut-down of the coiled tubing injector 160 or of a downhole motor or a downhole propulsion system connected to the coiled tubing. Any of a variety of warning techniques may be used. If, on the other hand, the inspection occurs as a post-processing event, more subdued warning methods such as pop-up windows, output logs, or printer outputs may be used. In either case, the warnings preferably display a copy of the image in which the defect was found and further include a longitudinal position or depth value to indicate the exact coordinates and position of the defect along the tubing. This feature allows operators to view the image to determine if the defect is indeed a cause for concern. If, however, the image is inconclusive, the depth value allows operators to locate the defect on the tubing and manually inspect the defect.

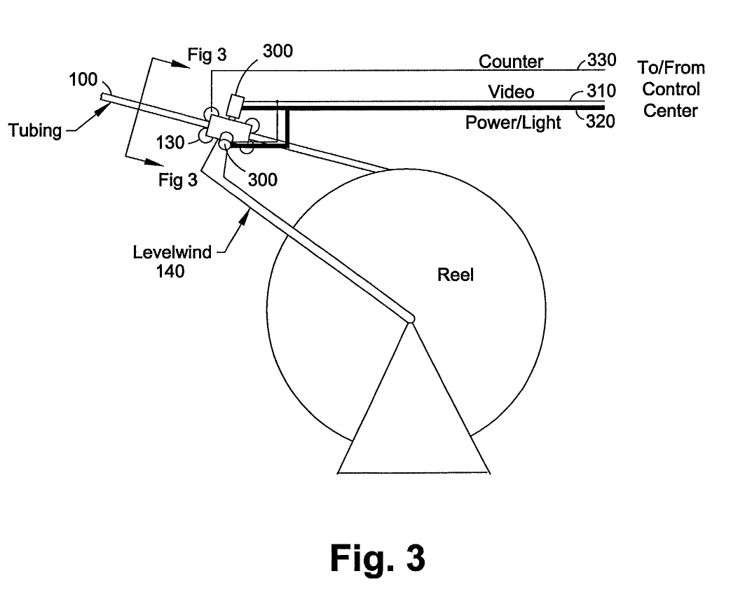

Referring now to FIG. 3, the configuration of the imaging devices is shown. FIG. 3 shows a coiled tubing reel 110 in accordance with the preferred embodiment comprising a spooled length of coiled tubing 100 for deployment into the borehole of a well and a levelwind 140 with guide rollers 130 for positioning the tubing as it is spooled on and off the reel 110. In addition, a number of imaging devices 300 are situated in close proximity to the guide rollers 130 on the levelwind 140. The imaging devices 300 are preferably configured to capture and transmit video images of the tubing 100 as the tubing passes through the guide rollers 130. These images are transmitted along video cables 310 to control center 200 for further processing. As alternatives to long, cumbersome cables, the video signals may also be transmitted to the control center 200 via RF transceivers or other wireless means. Additional cables 320 are provided to deliver power and/or light for the imaging devices 300.

To successfully correlate images captured from the imaging devices 300 with a position on the tubing 100, a counter signal 330 is transmitted along with the video signals to the control center 200. The counter signal may be a digital representation of the length of tubing that has passed by the imaging devices or may alternatively represent the rotational velocity of the guide wheels 130 as the tubing is spooled off the reel 110. In the latter configuration, the rotational velocity of the wheels may be integrated by the inspection processing system over time to correlate a longitudinal depth position with images captured by the imaging devices 300. Other methods of correlating images and position are certainly possible as will be recognized by those skilled in the art. For instance, an alternative embodiment may generate the counter/depth measurement at some location other than that shown in FIG. 3.

Another advantage of monitoring the counter information at the control center 200 is that the inspection system may be fully automated. That is, computer system 210 may be configured to begin monitoring incoming video signals only if the counter signal indicates that the tubing is moving. Conversely, if the tubing is not moving (or if the tubing is moving below a small threshold), the inspection system can be idled or disabled, thereby eliminating the need to transmit power and or light signals to the imaging devices continuously. Disabling the inspection system may also advantageously eliminate the possibility of capturing duplicate images.

The counter information may also be derived from other locations such as the reel 110 (based on reel rotation) or the injector 160 (based on tubing feed rates). In any event, it is envisioned that the maximum rate of the tubing should be 2500 ft/hour (˜8.3 inches per sec.) to permit the inspection system to capture and process between 3 and 5 images from each device 300 per second. Naturally, these numbers are target numbers and variations are permissible so long as the inspection system is capable of satisfactorily identifying defects along the entire length of tubing.

The imaging devices 300 are preferably charge coupled device (“CCD”) cameras available off the shelf from any of a variety of vendors. Both standard and backlit CCD cameras are sufficient for the purposes of capturing these images. Furthermore, the image capturing device may be of the staring or scanning variety. Additionally, the camera may transmit analog or digital video signals, but it is envisioned that a digital CCD would need a minimum resolution of 640×480 pixels of resolution with an 8 bit per pixel color or grayscale depth. While a CCD camera is employed in the preferred embodiment, it is certainly feasible that a number of other imaging devices such as a CMOS image sensor cameras or infrared imaging devices may also work for the intended purpose of capturing images of the coiled tubing.

As an alternative to the photoconductive imaging devices just described, fiber optic imaging devices may also be implemented to generate video images of the coiled tubing 100. In this alternative embodiment, the fiber optic cable over which the illuminating light and captured images travel extends from the tubing 100 and back to the control center 200. This configuration offers the advantage of eliminating the need to transmit power to the imaging devices 300 because the light source and image gathering equipment are located in the control center 200, preferably in close proximity to the image processing computer 210 and video storage device 260.

It is envisioned that the preferred inspection system must operate at any time of the day and under various weather conditions. Thus, the imaging devices 300 are preferably provided with an integrated light source. Alternatively, an auxiliary light source may be coupled to each imaging device. Another alternative is to provide light via (non-imaging) fiber optic cables. A fiber optic light source may be preferable to incandescent or halogen light (i.e., bulb) sources because the latter requires an additional power supply to turn the light source on. This is not to say that a fiber optic lighting system does not have the same power requirements, but merely that this power only needs to be provided to the light source which may be located in a remote, environment-safe enclosure such as the control center 200. The fiber optic cable passively transmits light from the source to the imaging devices 300 to illuminate the tubing 100. Furthermore, a common fiber optic light source may be used to illuminate the tubing 100 for all imaging devices 300. To satisfy the weather-proof requirement, the imaging devices 300 and light sources may be enclosed in a weather-proof, explosion-proof and/or shatter-proof enclosure (not specifically shown in FIG. 2).

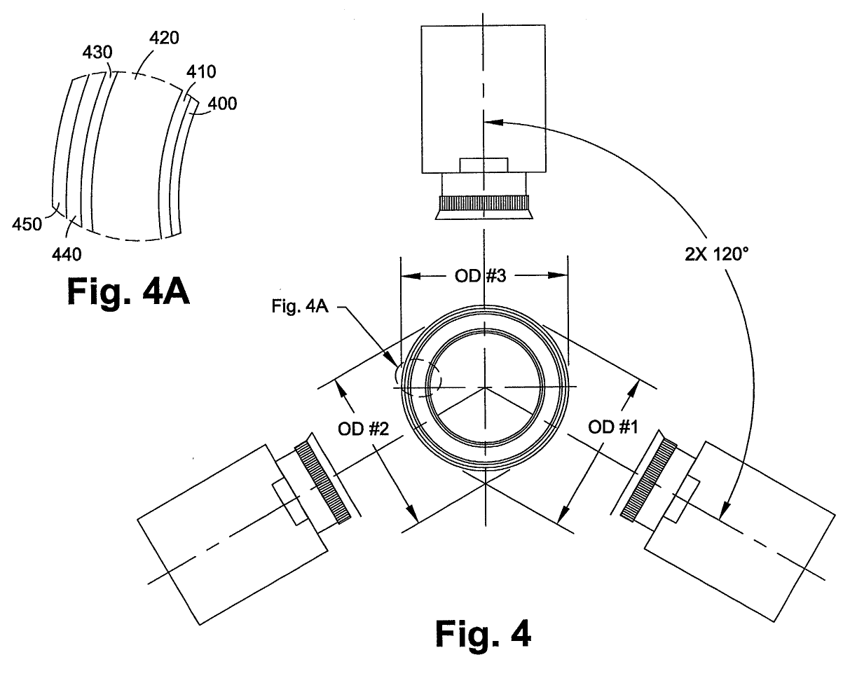

Referring now to FIG. 4, and in accordance with the preferred embodiment, the inspection system preferably includes three identical imaging devices 300 as shown. The imaging devices 300 are preferably positioned 120° apart from one another in the azimuth direction and centered about the central, longitudinal axis of the coiled tubing. The distance between the imaging devices and the longitudinal axis of the tubing 100 is necessarily determined by the focal length of the optics in the imaging device 300 and is ideally such that a focused image of the tubing fills a substantial portion of the aperture of the imaging device. In this configuration, each individual imaging device 300 captures an image of approximately one third of the tubing as it travels past the imaging devices. Each imaging device realistically “sees” one side (or half) of the tubing 100, but the fringes of the image may be distorted because of the curvature and motion of the tubing. Consequently, in the preferred configuration, images captured by the individual imaging devices 300 will overlap and provide some measure of certainty that a defect at the edge of an image will be detected by at least one, if not two, of the imaging devices. The same logic might suggest that 4 or more imaging devices may provide even more certainty that a defect in the tubing will be found. Unfortunately, additional video or images place additional processing requirements on the computer hardware and software. Thus, a “more is better” approach is generally true in terms of system reliability as long as the capacity of the image processing or storage system is not exceeded.

As shown in FIGS. 3 and 4, the longitudinal position of the imaging devices is preferably the same for each of the three imaging devices. This is done for, among other factors, space and packaging considerations, but there is no reason why the imaging devices could not be placed in a staggered configuration. A staggered configuration may allow the imaging and processing functions to occur serially instead of in parallel and thereby provide some measure of relief if the pattern recognition software is not capable of processing more than one image at a time. However, as discussed above, the preferred embodiment also incorporates a stacking function where images are combined and correlated with a counter value to correctly identify the position of defects flagged by the system. As such, the preferred configuration is well suited for this stacking function.

Referring still to FIG. 4, and as mentioned above, each of the imaging devices 300 captures an image of one half of the tubing 100. Given that the tubing 100 and imaging devices 300 are constrained, the image may advantageously provide a qualitative measure of the outside diameter of the tubing in a direction normal to the line of sight of the imaging device 300. In fact, feature measurement is a function that the preferred pattern recognition software 220 executes. Thus, in addition to defect recognition, the inspection system is also capable of measuring the overall diameter of the tubing in several locations (i.e., one for each imaging device 300). These diameter measurements are preferably checked by computer system 210 against an upper and lower tolerance to verify that tension and compression of the composite tubing has not affected the structure of the tubing 100.

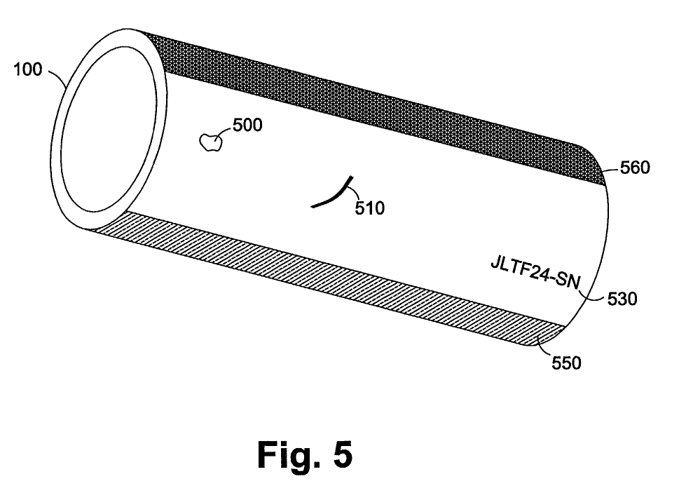

FIG. 4A shows a detailed cross section of a representative coiled tubing according to the preferred embodiment. The coiled tubing preferably comprises concentric layers of various materials beginning with the an inner liner of impermeable PVDF 400. The next layers are comprised of carbon fiber 420 bounded on either side by fiberglass 410 and 430. Another layer of impermeable PVDF 440 follows and the outermost wear layer 450 is another layer of fiberglass. The thickness of this wear layer is preferably 1/16^{th} inch although other thicknesses are certainly permissible. The outermost PVDF layer 440 is preferably a distinctly different color than the outer wear layer 450. In the preferred embodiment, the wear layer is a predominantly gray color and the PVDF layer underneath is a lighter white color. The contrasting difference in color allows the inspection system and operators to literally “see” when the wear layer has worn away due to abrasion or other forces. The pattern recognition software preferably identifies this contrast in color, which will appear as a contrasting region as depicted in FIG. 5.

FIG. 5 shows an isometric view of a representative portion of tubing 100. The preferred tubing inspection system is configured to recognize and flag features of the type shown in FIG. 5. Namely, the generally circular feature 500 may represent a region of wear, a large pit, or some other defect. Defect 500 may also represent the contrasting color of the layer 440 underneath the wear layer 450. It is envisioned that the inspection system will flag features of this type that are roughly 1 square inch in size. However, as noted previously, this threshold may be incorporated as a user adjustable threshold.

FIG. 5 also shows a representative crack 510 that may be detected by the preferred embodiment. The outermost layer of composite coiled tubing preferably includes fibers that lay in a predominantly spiraled pattern. Thus, many cracks that appear in the outer layer will follow this spiral direction presumably due to separation of the fibers that comprise the layer 450. The crack 510 shown in FIG. 5 represents this sort of angled crack. As with the generally circular defect 500 discussed above, the inspection system is ideally configured to detect cracks larger than a predetermined, yet adjustable threshold. For example, the inspection system should preferably detect cracks larger than 0.03″ in width by 0.50″ in length.

Whereas it is a desirable goal of the preferred embodiment to detect unwanted defects 500, 510 such as those shown in FIG. 5, it is equally desirable to ignore features that are known not to be defects such as manufacturing inscriptions or patterns. As such, users of the preferred inspection system may advantageously train the pattern recognition system and create rules to ignore alphanumeric FIGS. 530 or other preexisting features such as lines or stripes 550, 560, which may be of different colors or may have a distinctive pattern.

The longitudinal stripes 550, 560 on the coiled tubing 100 are included for another contemplated feature of the preferred inspection system. To this point in the description of the preferred embodiment, the pattern recognition software 220 has extracted features from images captured by the imaging devices 300 and 1) determined if the feature is a defect and if so, 2) compared the size of the defect against a user-determined threshold. However, it may also be desirable to compare an image of a defect against a prior image of the same defect to determine if that defect is changing in size. To incorporate this feature, some method of determining the circumferential position of a feature is required. To that end, stripes 550, 560 are imprinted on the outer surface of the coiled tubing along the entire length of the tubing. The stripes 550, 560 are preferably distinguishable by color, thickness, or pattern. The advantage of these stripes comes from the fact that the tubing 100 may rotate during injection into and removal from the well. Consequently, features of interest will invariably appear at different locations in subsequent images. Without a reference such as that provided by the stripes, defects might not be properly recognized.

By way of example with respect to FIG. 5, one of the imaging devices 300 captures video images of the coiled tubing 100 as it moves through the levelwind 140 and into the well. The image capturing device may be of the staring or scanning variety. It should be understood that the video image is like a still photo or frame of film capturing a picture of a small segment of the coiled tubing 100 at a given point in time along the length of the tubing 100 as the coiled tubing moves down hole. The imaging device 300 may capture 15 to 20 or more video images per second with the tubing 100 preferably moving through the levelwind 140 at a rate no greater than about 8 inches of tubing per second. Thus the imaging device may capture 15 to 20 images of this 8 inch length of tubing 100 as it passes the imaging device 100. Preferably, the inspection system only processes 3 to 5 of these images for inspection. Although the imaging device 300 may transmit analog or digital video signals, it is envisioned that a digital CCD would be used generating an image with a minimum resolution of 640×480 pixels of resolution with an 8 bit per pixel color or grayscale depth. If analog imaging devices 300 are used, it is envisioned that the frame grabber 270 or other image capturing device in computer 210 generate images with this same resolution and color depth for delivery to the image pattern recognition software 210. Images with greater resolution and color depth may also be used with limitations defined by storage and processing capacities.

Preferably, a longitudinal coordinate of the tubing 100 is determined for the tubing segment which has been captured by the video imaging device 300. By knowing the longitudinal coordinate, the tubing segment of the captured video images may later be identified for subsequent inspection and review. The longitudinal coordinate on the tubing may be determined by various means to properly locate and identify the segment of tubing which has been recorded by the 3 to 5 captured video images. One preferred method is the correlation of the counter signal with the captured video images. A counter signal is typically made by means well known in the art to continuously determine the length of the coiled tubing extending into the borehole. This counter signal provides the longitudinal coordinate for the tubing segment providing the captured video images. The counter signal 330 is transmitted along with the video signals to the control center 200 to provide a digital representation of the length of tubing that has passed by the imaging device. Alternatively, the longitudinal coordinate may be determined by the rotational velocity of the guide wheels 130 as the tubing is spooled off the reel 110 as discussed above. Still another method may be the relationship of the rate of the tubing passing through the levelwind 140 with the rate of the taking of the video images of the tubing 100 by the imaging device 300. Even another method includes the use of stripes on the tubing, as hereinafter described, to determine the longitudinal coordinate of the captured video images of the tubing 100. Other methods of correlating images and position are certainly possible as will be recognized by those skilled in the art.

Video images from the imaging device 300 are transmitted back to the control center where the images from the imaging device 300 are stacked by video stacker 250 with one another and stamped or otherwise identified with a corresponding longitudinal position on the coiled tubing 100. The position information is provided via a counter signal. The stacking function of stacker 250 may be executed by computer logic or any standard video recording equipment for correlating the video images with the position counter information. It is certainly feasible for the stacking function to be executed by computer 210 or a completely separate computer (not shown). The video images may be transmitted to computer system 210 either in real-time from the imaging device 300 or from the recorded media in video recorder 260. The frame grabber 270 or some other suitable video board in the computer system 210 generates images from the incoming video signals that are recognizable by the pattern recognition software 220.

Computer system 210 is configured to execute image processing and pattern recognition software 220. The image processing and pattern recognition software 220 receives each captured image with pixel and position information and performs a variety of standard image analysis functions on the pixel information including morphology, segmentation, filtering, edge detection, and measurement. In addition the software performs pattern recognition and classification tasks using information gathered from the above functions.

The image processing and pattern recognition software 220 is programmed to analyze, recognize and classify predetermined features on the tubing 100. The software uses binary and fuzzy logic to create rules about how information extracted from the captured images should be interpreted. These rules are created and altered via a graphical user interface. By way of example and not by way of limitation, the image processing and pattern recognition software 220 is programmed to analyze, recognize and classify such tubing features as wear, cracks, patterns, abrasions, color, discolorations, dimensions, or defects and ignore other features such as manufacturer's marking. Not only will the image processing and pattern recognition software 220 detect these predetermined features, but can recognize and classify the size of such features such that the image processing and pattern recognition software 220 will only report features with a minimum predetermined set of dimensions. The image processing and pattern recognition software 220 may also determine the variance in diameter of the tubing 100 over its length so as to provide an indication of wear for example.

The image processing and pattern recognition software 220 monitors the incoming captured images, analyzes and classifies the images, and then extracts predetermined features from the images. Features which are defects are flagged by either generating an interrupt or otherwise notifying the computer operating system or processor that a defect has been detected. The computer 210 then generates a warning 280 to alert the system operator of the defect. If the inspection occurs real-time, the alert may be a warning message on a computer screen or the computer may initiate a more significant warning event such as turning on flashing lights, or perhaps even forcing a shut-down of the coiled tubing injector 160 or of a downhole motor or a downhole propulsion system connected to the coiled tubing. Any of a variety of warning techniques may be used. If, on the other hand, the inspection occurs as a post-processing event, more subdued warning methods such as pop-up windows, output logs, or printer outputs may be used. In either case, the warnings preferably display a copy of the image in which the defect was found and further include a longitudinal position or depth value to indicate the exact coordinates and position of the defect along the tubing. This feature allows operators to view the image to determine if the defect is indeed a cause for concern. If, however, the image is inconclusive, the depth value allows operators to locate the defect on the tubing and manually inspect the defect.

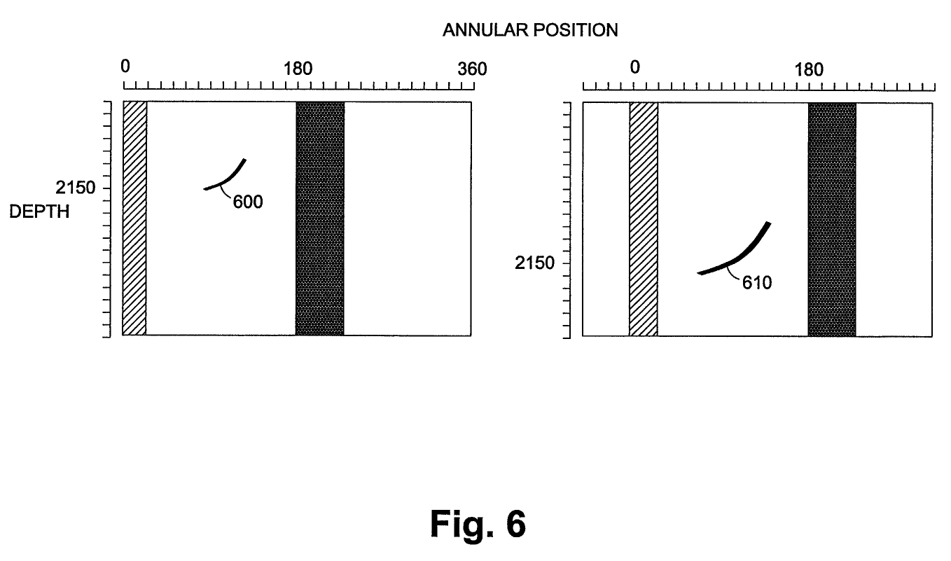

An example of how stripes 550, 560 and the depth counter value discussed above can be used to monitor the growth of a defect is shown in FIG. 6. FIG. 6 shows a representation of two images of the same defect in a tubing 100 taken at different times. Each image represents a “stacked” image or a combined image representing the entire tubing 100 as photographed by the three imaging devices 300 as discussed above. Thus, the image may in fact be represented by the single images shown or by three sub-images. For the images shown in FIG. 6, the vertical axis represents a depth count and the horizontal axis represents a circumferential position on the tubing thus providing coordinates. Note that one of the stripes 550 signifies the origin of a circumferential position on the tubing 100. In the image on the left, the defect 600 may have, at the time of inspection, produced a warning because its size surpassed the user-designated threshold. However, upon further visual inspection, an operator may classify the crack as cosmetic in nature, but worthy of further monitoring. As a result, the defect is stored by computer system 210 along with key information identifying the defect (e.g., size and location). The defect 600 is then monitored on subsequent runs, but will not generate warnings unless the defect grows beyond a certain percentage of its original size. Notice however, that on a subsequent run (image on the right), the defect 610 has not only grown, but is also in a different location within the image. Without the depth and circumferential position coordinates information, it is unlikely that the defect could be identified as the previously flagged defect.

As previously described, it is preferred to use three imaging devices 300 to ensure complete coverage and monitoring of the entire outer surface of the tubing 100. One imaging device will capture an image of only one 180° side of the tubing 100 and the edges of the tubing, shown in the images, may be distorted due to the curvature of the tubing at the edges. Thus, the imaging devices 300 are preferably positioned 120° apart from one another in the azimuth direction and centered about the central, longitudinal axis of the coiled tubing 100 so as to overcome this distortion and ensure a complete coverage of the entire surface of the tubing 100. With three imaging devices 100 positioned 120° apart but captured images of 180° sides of the tubing 100, there will be an overlap along the borders of the captured images. As previously described, the stripes 550 provide a circumferential reference in the images to the tubing 100 such that the overlap in the images may be identified and eliminated if desired. For example, a 360° view of the tubing 100 could be generated by combining the three images and eliminating the overlaps. More particularly, the stripes allow different imaging runs of the tubing 100 taken at different times to be compared since both longitudinal and circumferential coordinates are provided for each captured image of a given tubing segment.

Accordingly, the above described embodiments disclose a fully automated defect inspection system that uses image pattern recognition and classification to identify defects over a continuous length of coiled tubing. The above discussion is meant to be illustrative of the principles and various embodiments of the present invention. Numerous variations and modifications will become apparent to those skilled in the art once the above disclosure is fully appreciated. For example, whereas the discussion has centered around the inspection of composite coiled tubing commonly used in oil well drilling, it is certainly feasible that the preferred inspection system may also be used to inspect continuous lengths of tubing constructed of other materials, including metallic tubing. Furthermore, the above disclosed invention is fully extendible to initial quality control or field inspection of tubing used in applications other than oil well drilling. It is intended that the following claims be interpreted to embrace all such variations and modifications.

While a preferred embodiment of the invention has been shown and described, modifications thereof can be made by one skilled in the art without departing from the spirit of the invention.

What is claimed is:

1. An inspection system for coiled tubing being employed in a well, the system comprising:
an imaging device recording video signals of a segment of the coiled tubing as the coiled tubing is being employed into the well;
a conductor transmitting the video signals to a processor;
an image grabber generating an image of the tubing segment from the video signals; and
a program in the processor analyzing the image to detect predetermined features of the tubing segment.

2. The system of claim 1 further including means for generating longitudinal coordinates of the tubing segment.

3. The system of claim 2 wherein the longitudinal coordinates of the tubing are stamped on the image of the tubing segment.

4. The system of claim 1 wherein the video signals have a minimum resolution of 640×480 pixels with an 8 bit per pixel color or grayscale depth.

5. The system of claim 1 further including a video stacker stacking the images.

6. The system of claim 1 wherein the processor is programmed to recognize and classify the predetermined features on the tubing segment shown in the image.

7. The system of claim 1 wherein the predetermined features include one or more of the following: wear, cracks, patterns, abrasions, color, discolorations, or dimensions.

8. The system of claim 1 wherein the predetermined features include the diameter of the tubing.

9. The system of claim 1 wherein the processor generates a signal upon detecting a defect in the tubing so as to provide a warning of such defect.

10. A tubing for use with an automated defect inspection system comprising:
an outer wear layer; and
a contrasting layer beneath the wear layer;
wherein if the outer wear layer is worn away, the contrasting layer becomes visible as a contrasting feature on the tubing.

11. The tubing of claim 10, further comprising at least one stripe located on the outer wear layer and parallel to the longitudinal axis of the tubing.

12. The tubing of claim 11, wherein if more than one stripe is located on the outer wear layer, the stripes are individually distinguishable.

13. An inspection system comprising:
a composite coiled tubing having layers of fibers forming a tubing wall;
an outermost layer having a longitudinal stripe;
an imaging device recording video signals of a segment of the coiled tubing as the coiled tubing is presented before the imaging device;
a processor receiving the video signals from the imaging device; and
a program in the processor analyzing the video signals to detect the stripe on the tubing segment.

14. The system of claim 13 wherein the tubing has at least one outer layer having a predetermined color and the program analyzes the video signals to detect the predetermined color on the tubing segment.

15. An automated inspection system for identifying defects in coiled tubing, comprising:
a computer system configured to execute pattern recognition software; and
a plurality of imaging devices configured to capture video images of coiled tubing as the tubing passes in front of the imaging devices;
an image being transmitted to the computer system and the pattern recognition software analyzing the image, extracting features from the image, and generating a indication if a defect is identified in the image.

16. The inspection system of claim 15 wherein the imaging devices are fiber-optic imaging devices.

17. The inspection system of claim 15 wherein the plurality of imaging devices consist of three CCD cameras.

18. The inspection system of claim 15 further comprising:
a counter signal identifying a location along the coiled tubing; and
the computer system reading the counter signal to identify the location along the coiled tubing at which a defect is located.

19. The inspection system of claim 18 wherein if the counter signal indicates that the coiled tubing is not moving or moving slower than a threshold, the inspection system is disabled.

20. The inspection system of claim 18 wherein if the counter signal indicates that the coiled tubing is moving faster than the threshold, the inspection system is enabled.

21. The inspection system of claim 18 further comprising a video stacker configured to correlate video images taken from the plurality of imaging devices with one another as well as with a longitudinal position along the coiled tubing using the counter signal.

22. The inspection system of claim 15 wherein the video images are transmitted to the computer system for real time identification of defects.

23. The inspection system of claim 15 further comprising a video recorder configured to store the video images from the plurality of imaging devices for later defect identification.

24. The inspection system of claim 15 wherein the coiled tubing comprises at least one longitudinal stripe on the outer surface of the tubing as a reference for the purpose of identifying the annular location of a feature on the tubing.

25. The inspection system of claim 15 wherein the pattern recognition software further measures the outside diameter of the tubing and generates an indication if the diameter is outside a user-designated tolerance range.

27. A computer system for use in an automated tubing inspection system comprising:
a processor;
at least one output device;
an input device configured to receive video signals and generate sequential images from the video input;
a pattern classification software program configured to read the images and extract features from the images and compare the size of these features against user-defined thresholds;
wherein if the pattern classification software determines that the size of the features does not fall within the user-defined threshold, the software generates an interrupt indicating that a defect has been located.

28. The computer system of claim 27 further comprising:
an input for receiving location data indicating the position from which the incoming images are taken;
wherein when the pattern classification software generates the warning interrupt, the computer system transmits the image containing the defect and the corresponding location data to the output device.

29. The computer system of claim 28 wherein the output device is a printer.

30. The computer system of claim 28 wherein the output device is a monitor.

31. The computer system of claim 28 wherein the pattern classification software may be trained to recognized unwanted defects and ignore innocuous features.

32. A method of identifying defects in a continuous length of coiled tubing, comprising:
passing the continuous length of coiled tubing in front of a plurality of imaging devices;
capturing images of the outer circumference of the tubing with the imaging devices and transmitting the images to a processor;
receiving the images by the processor and inputting the images to computer vision software running on the processor; and
processing the images on the computer vision software; and
identifying predetermined features in the tubing.

33. The method of claim 32 further including initiating a warning event upon detecting a defect in the tubing.

34. The method of claim 32 wherein the passing step includes guiding the coiled tubing through a guide roller mechanism as the tubing is spooled on or off a storage reel and placing the aperture of a plurality of imaging devices in close proximity to the guide roller mechanism.

35. The method of claim 32, further comprising:
transmitting a depth counter value the processor to identify the position along the tubing at which the images are taken; and
displaying the image of the features.

36. The method of claim 35 further including indicating the position of a defect in the tubing.

37. The method of claim 32, further comprising:
specifying the annular location of a predetermined feature with respect to an annular reference established by at least one longitudinal stripe located on the outer diameter of the tubing ; and
indicating the annular position of the predetermined features.

38. The method of claim 32, further comprising transmitting power to operate the imaging devices and transmitting light to illuminate the tubing.

39. The method of claim 32, wherein the imaging devices are located on a levelwind that is coupled to a reel on which the tubing is coiled.

40. The method of claim 32, further comprising storing the images on recordable media prior to processing the images.

41. The method of claim 40, further comprising storing the images with the depth counter value.

42. The method of claim 32, further comprising identifying a feature as a defect by determining if the size of an unrecognized feature exceeds a user-designated threshold.

43. The method of claim 32, further comprising identifying a feature as a defect by determining if the size of a previously recognized defect has grown beyond a user-designated percentage of its original size.
